(19) United States
(12) Patent Application Publication
(10) Pub. No.: US 2025/0316734 A1
(43) Pub. Date: Oct. 9, 2025

(54) FUEL CELL SYSTEM AND METHOD FOR CONTROLLING THE SAME

(71) Applicants: Hyundai Motor Company, Seoul (KR); Kia Corporation, Seoul (KR)

(72) Inventor: Byeong Eun Cho, Incheon (KR)

(21) Appl. No.: 18/825,127

(22) Filed: Sep. 5, 2024

(30) Foreign Application Priority Data
Apr. 9, 2024 (KR) 10-2024-0048192

(51) Int. Cl. H01M 8/04828; H01M 8/0432; H01M 8/04492; H01M 8/04701

(52) U.S. Cl. CPC H01M 8/04835; H01M 8/04358; H01M 8/045; H01M 8/04708

(57) ABSTRACT

A fuel cell system is introduced. The fuel cell system may comprise a fuel cell stack, and a controller configured to determine a dew point of gas flowing in the fuel cell stack, determine, based on the determined dew point and an operating temperature of the fuel cell stack, a change rate of an amount of hydrogen crossover, and control, based on a target operating temperature, the operating temperature of the fuel cell stack, wherein the target operating temperature is changed based on the determined change rate.

### CROSS REFERENCE TO RELATED APPLICATION

The present application claims priority to Korean Patent Application No. 10-2024-0048192, filed on Apr. 9, 2024, the entire contents of which is incorporated herein for all purposes by reference.

### TECHNICAL FIELD

The present disclosure relates to a fuel cell system for reducing hydrogen crossover in a fuel cell stack and a method for controlling the same.

### BACKGROUND

The matters described in this Background section are only for enhancement of understanding of the background of the disclosure, and should not be taken as acknowledgement that they correspond to prior art already known to those skilled in the art.

Fuel cell vehicles include a fuel cell system which is configured to include a stack that generates electricity by generating electrical energy through an electrochemical reaction between fuel and oxidizer, a fuel supply device that supplies fuel gas to the anode of the stack through a fuel gas supply passage, an air supply device that supplies air containing oxygen to the cathode of the stack through an oxidizing gas supply passage, a thermal management device that controls the operating temperature of the stack, a control device that controls the operation of the fuel cell system, and the like.

In such a fuel cell system, hydrogen that is a fuel is oxidized at an anode (oxidation electrode), and thus hydrogen ions and electrons are generated. The anode hydrogen ions penetrate an electrolyte membrane, and move to a cathode (or a reduction electrode). At the cathode, oxygen is reduced and water is generated.

Meanwhile, in case that the fuel cell vehicle is stopped, the fuel cell stack maintains a state in which power generation is stopped. In this case, the supply of hydrogen to the fuel cell stack is maintained and the supply of air is blocked. In case that this situation continues, the hydrogen concentration on the anode side of the fuel cell stack increases, and a concentration imbalance occurs inside the fuel cell stack, causing hydrogen to crossover from the anode side to the cathode side in the fuel cell stack.

If hydrogen crossovers to the cathode side of the fuel cell stack, a complex potential may be formed within the cathode, hydrogen peroxide may be generated, or radicals may be generated. These may deteriorate the performance of the fuel cell stack by deteriorating the catalyst or electrolyte membrane formed on the cathode side of the fuel cell stack.

Therefore, in order to ensure the performance of the fuel cell stack, a technology to prevent hydrogen from crossing over to the cathode side of the fuel cell stack is considered.

### SUMMARY

According to the present disclosure, a fuel cell system may comprise a fuel cell stack, and a controller configured to determine a dew point of gas flowing in the fuel cell stack, determine, based on the determined dew point and an operating temperature of the fuel cell stack, a change rate of an amount of hydrogen crossover, and control, based on a target operating temperature, the operating temperature of the fuel cell stack, wherein the target operating temperature is changed based on the determined change rate. The fuel cell system, wherein the controller is configured to determine, based on the fuel cell stack entering an idle state, the dew point.

The fuel cell system, wherein the controller is configured to determine at least one of an outlet temperature value of coolant discharged from the fuel cell stack or a relative humidity value at a cathode outlet of the fuel cell stack, and determine, based on the at least one of the determined outlet temperature value or the relative humidity value, the dew point.

The fuel cell system, wherein the controller is configured to determine, based on a pre-stored derivation equation, the change rate of the amount of hydrogen crossover, wherein the pre-stored derivation equation derives, based on the operating temperature and the determined dew point, the change rate of the amount of hydrogen crossover.

The fuel cell system, wherein the controller is configured to change, based on a temperature reduction range and the determined change rate satisfying a range condition, the target operating temperature to a lower level, and control, based on the target operating temperature changed to the lower level, the operating temperature of the fuel cell stack.

The fuel cell system, wherein the controller is configured to determine, based on the determined change rate not satisfying a range condition, a sign of the change rate, change, based on the determined sign of the change rate being positive and a first coefficient of variation, the target operating temperature to a lower level, and control, based on the target operating temperature changed to the lower level, the operating temperature of the fuel cell stack.

The fuel cell system, wherein the controller is configured to determine, based on the determined change rate not satisfying the range condition and the determined sign of the change rate being negative, at least one of an outside temperature or a magnitude of the change rate, and based on the outside temperature being less than a reference temperature or the magnitude of the change rate being less than a reference magnitude and a second coefficient of variation being greater than the first coefficient of variation, change the target operating temperature to a lower level.

The fuel cell system, wherein the controller is configured to based on the determined change rate not satisfying the range condition, the determined sign of the change rate being negative, the outside temperature being greater than or equal to a reference temperature or a magnitude of the change rate being greater than or equal to a reference magnitude, and the first coefficient of variation, change the target operating temperature to a high level, and control, based on the target operating temperature changed to the higher level, the operating temperature of the fuel cell stack.

The fuel cell stack, wherein the controller is configured to control, based on the target operating temperature changed to a higher level and using a temperature-raising device connected to the fuel cell stack, the operating temperature of the fuel cell stack, and control, based on the target operating temperature changed to a lower level and using a heat radiation device connected to the fuel cell stack, the operating temperature of the fuel cell stack.

The fuel cell stack, wherein the controller is configured to determine, based on the fuel cell stack reaching the target operating temperature and the fuel cell stack entering an idle state, an idle state maintenance time, and set, based on the determined idle state maintenance time exceeding a reference time, a control limit range of the operating temperature for the fuel cell stack.

According to the present disclosure, a method for controlling a fuel cell system, the method may comprise determining a dew point of gas flowing in a fuel cell stack of the fuel cell system, determining, based on the determined dew point and an operating temperature of the fuel cell stack, a change rate of an amount of hydrogen crossover, and controlling, based on a target operating temperature, the operating temperature of the fuel cell stack, wherein the target operating temperature is changed based on the determined change rate.

The method, wherein the determining the dew point may comprise determining, based on the fuel cell stack entering an idle state, the dew point.

The method, wherein the determining the change rate may comprise determining, based on a pre-stored derivation equation, the change rate of the amount of hydrogen crossover, wherein the pre-stored derivation equation derives, based on the operating temperature and the determined dew point, the change rate of the amount of hydrogen crossover.

The method, wherein the controlling may comprise changing, based on a temperature reduction range and the determined change rate satisfying a range condition, the target operating temperature to a lower level, and controlling, based on the target operating temperature changed to the lower level, the operating temperature of the fuel cell stack.

The method, wherein the controlling may comprise determining, based on the determined change rate not satisfying a range condition, a sign of the change rate, changing, based on the determined sign of the change rate, the target operating temperature to a lower level, and controlling, based on the target operating temperature changed to the lower level, the operating temperature of the fuel cell stack.

The method, wherein the changing the target operating temperature to the lower level may comprise changing, based on the determined sign of the change rate being positive and a first coefficient of variation, the target operating temperature to the lower level, or determining, based on the determined sign of the change rate being negative, at least one of an outside temperature or a magnitude of the change rate, and based on the outside temperature being less than a reference temperature or the magnitude of the change rate being less than a reference magnitude and a second coefficient of variation being greater than the first coefficient of variation, changing the target operating temperature to the lower level.

The method, wherein the controlling may comprise changing the target operating temperature to a high level, wherein the changing the target operating temperature to the high level is based on the determined change rate not satisfying the range condition, the determined sign of the change rate being negative, an outside temperature being greater than or equal to a reference temperature or a magnitude of the change rate being greater than or equal to a reference magnitude, and a first coefficient of variation, and controlling, based on the target operating temperature changed to the higher level, the operating temperature of the fuel cell stack.

The method, may further comprise, after the controlling, determining, based on the fuel cell stack reaching the target operating temperature and the fuel cell stack entering an idle state, an idle state maintenance time, and setting, based on the determined idle state maintenance time exceeding a reference time, a control limit range of the operating temperature for the fuel cell stack.

The method, wherein the determining the dew point may comprise determining at least one of an outlet temperature value of coolant discharged from the fuel cell stack or a relative humidity value at a cathode outlet of the fuel cell stack, and determining, based on the at least one of the determined outlet temperature value or the relative humidity value, the dew point.

The method, wherein the controlling may comprise controlling, based on the target operating temperature changed to a higher level and using a temperature-raising device connected to the fuel cell stack, the operating temperature of the fuel cell stack, or controlling, based on the target operating temperature changed to a lower level and using a heat radiation device connected to the fuel cell stack, the operating temperature of the fuel cell stack.

### BRIEF DESCRIPTION OF THE DRAWINGS

FIG. 1 shows an example of the configuration of a fuel cell system according to an example of the disclosure.

FIG. 2, FIG. 3 and FIG. 4 show examples of changing the target operating temperature based on a change rate according to an example of the disclosure.

FIG. 5 and FIG. 6 show examples of a method for controlling a fuel cell system according to an example of the disclosure.

### DETAILED DESCRIPTION

In the following description, if a detailed description of known techniques associated with the disclosure would unnecessarily obscure the gist of the disclosure, detailed description thereof will be omitted. In addition, the attached drawings are provided for easy understanding of examples of the specification and do not limit technical spirits of the disclosure, and the examples should be construed as including all modifications, equivalents, and alternatives falling within the spirit and scope of the disclosure.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

In addition, the term “unit” or “control unit” included in names such as a fuel cell control unit (FCU) is a term widely used to name a controller for controlling a specific function of a vehicle, but does not mean a generic function unit.

A controller may include a communication device configured to communicate with another control device or sensor to control a function assigned thereto, a memory configured to store an operating system or logic command and input/output information, and one or more processors configured to perform determination, calculation, decision, etc. used for controlling the function assigned thereto.

Hereinafter, examples of the disclosure will be described in detail with reference to the attached drawings. Regardless of the reference numerals, identical or similar components will be given the same reference numbers and duplicate descriptions thereof will be omitted.

An object of the disclosure is to prevent hydrogen from crossing over to the cathode side of the fuel cell stack to ensure the performance of the fuel cell stack.

Hereinafter, a fuel cell system and method of controlling the same according to an example of the disclosure will be described to achieve the above-described object.

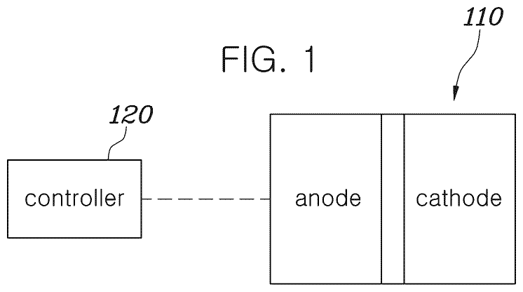

First, a fuel cell system according to an example of the disclosure will be described with reference to FIG. 1.

FIG. 1 shows an example of the configuration of a fuel cell system according to an example of the disclosure.

Referring to FIG. 1, a fuel cell system according to an example of the disclosure may include a fuel cell stack 110 and a controller 120. FIG. 1 mainly shows components related to an example of the disclosure, and it is apparent that fewer or more components may be included when implementing an actual fuel cell system.

Hereinafter, each component will be described.

The fuel cell stack 110 may be provided with an anode and a cathode, and the controller 120 may receive information from the fuel cell stack 110 to control the operating temperature of the fuel cell stack 110.

For example, the controller 120 according to an example of the disclosure may change the target operating temperature of the fuel cell stack 110 based on the operating temperature and dew point of the fuel cell stack 110 to prevent crossover of hydrogen from the anode side to the cathode side in the fuel cell stack 110. The dew point refers to a temperature at which water vapor present in the hydrogen or within the fuel cell environment begins to condense into liquid water. In the fuel cell stack 100, managing moisture may be performed because too much (e.g., flooding of the fuel cell stack) or too little water (e.g., drying out of the fuel cell stack) may impact the performance and longevity of the fuel cell stack 100.

In particular, if the fuel cell stack 110 is in an idle state, hydrogen crossover from the anode side to the cathode side in the fuel cell stack 110 may be actively performed, so the controller 120 may perform controlling to be described later if the fuel cell stack 110 enters an idle state. However, it is apparent that this is an example and the disclosure is not necessarily limited thereto.

Accordingly, the controller 120 may determine the dew point of gas flowing in the fuel cell stack 110, and in particular, may determine the dew point if the fuel cell stack 110 enters an idle state.

Then, the controller 120 may determine at least one of the outlet temperature of the coolant (e.g., water, glycol-water mixtures, ethylene glycol, propylene glycol, silicone-based coolants, fluorinated coolants, hydrocarbon-based coolants, and alcohol-based coolants, etc.) discharged from the fuel cell stack 110 and the relative humidity at the cathode outlet of the fuel cell stack 110, and determine the dew point based on the at least one determined value (e.g., the outlet temperature or the relative humidity). For example, the controller 120 may determine the dew point using Equation 1 below based on at least one determined value.

$${T}_{d p} = \frac{c γ ( T , RH )}{b - γ ( T , RH )} \qquad [ Equation 1 ]$$

In Equation 1 above, T_{dp} refers to the dew point, b is a correction constant, c is a first reference temperature constant, Tis the outlet temperature of coolant, and RH is the relative humidity at the cathode outlet. In this case, the correction constant b may correspond to the outlet temperature of the coolant. If the outlet temperature of the coolant is determined, the corresponding correction constant may be derived. Further, γ(T, RH) may be a variation constant, which may be derived by Equation 2 below.

$$γ ( T , RH ) = ln ( \frac{R H}{100} ) + \frac{b T}{c + T} \qquad [ Equation 2 ]$$

However, this is an example, and the dew point is not necessarily determined through Equations 1 and 2 described above. For example, the controller 120 may determine the dew point using Equation 3 below based on at least one of the outlet temperature of the coolant discharged from the fuel cell stack 110 and the relative humidity at the cathode outlet of the fuel cell stack 110.

$${T}_{dp} = \frac{c ln ( \frac{RH}{100} \frac{{P}_{s , m} ( T )}{a} )}{b - ln ( \frac{RH}{100} \frac{{P}_{s , m} ( T )}{a} )} \qquad [ Equation 3 ]$$

In Equation 3 above, a refers to a preset reference pressure value, and P_{s,m}(T) may refer to the pressure of the gas discharged from the fuel cell stack 110 according to the outlet temperature of the coolant. P_{s,m}(T) may be derived through Equation 4 below.

$${P}_{s , m} ( T ) = {ae}^{( b - \frac{T}{d} ) ( \frac{T}{c + T} )} \qquad [ Equation 4 ]$$

In this case, d may refer to a second reference temperature constant similar to c.

If the dew point is determined by the controller 120, the controller 120 may determine a change rate of an amount of hydrogen crossover according to the operating temperature of the fuel cell stack 110 considering the determined dew point. Specifically, the controller 120 may already store a derivation equation to derive the amount of hydrogen crossover according to the operating temperature of the fuel cell stack 110 and the dew point of the gas flowing in the fuel cell stack 110. In this case, the derivation equation may be an equation that represents a relationship between the operating temperature, dew point, and amount of hydrogen crossover, based on the amount of hydrogen crossover, which is derived by changing the operating temperature of the fuel cell stack 110 and the dew point of the gas flowing in the fuel cell stack 110 through a preliminary experiment.

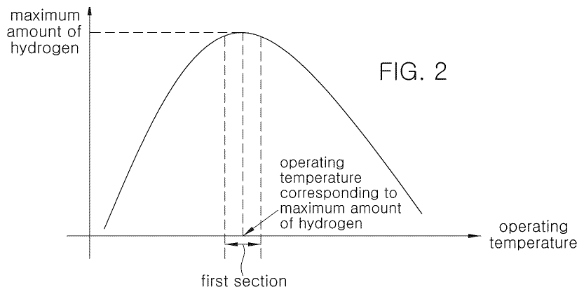

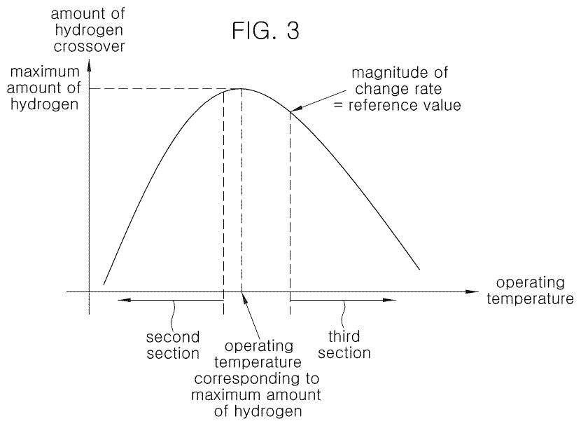

The controller 120 may determine the change rate of the amount of hydrogen crossover according to the operating temperature of the fuel cell stack 110 considering the dew point determined based on the previously stored derivation equation. In addition or alternative, the controller 120 may control the operating temperature of the fuel cell stack 110 by changing the preset target operating temperature based on the determined change rate. This will be explained in detail with reference to FIG. 2, FIG. 3 and FIG. 4.

FIG. 2, FIG. 3 and FIG. 4 show examples of changing a target operating temperature based on the change rate according to an example of the disclosure.

Referring to FIG. 2, FIG. 3 and FIG. 4, in a graph, the x-axis may represent the operating temperature of the fuel cell stack 110, and the y-axis may represent the amount of hydrogen crossover from the anode side to the cathode side in the fuel cell stack 110. The graph shown in FIG. 2, FIG. 3 and FIG. 4 may be a graph showing a change in the amount of hydrogen crossover according to the operating temperature for the specific dew point determined previously.

In addition or alternative, as shown in FIG. 2, FIG. 3 and FIG. 4, as the operating temperature (x) of the fuel cell stack 110 changes, the amount (y) of hydrogen that crossovers may appear in the form of a quadratic function, and the change rate (∂_{y}/∂ₓ) may refer to the slope of the tangent line of the quadratic function graph at a specific operating temperature.

The controller 120 may determine whether the determined change rate satisfies a preset range condition. For example, referring to FIG. 2, the preset range condition may be a range condition set based on the minimum and maximum change rates in the operating temperature range (e.g., a first section) formed near a point where the amount of hydrogen crossover is maximum. However, it is apparent that the above-mentioned range condition is an example and is not necessarily limited thereto. If the determined change rate satisfies the preset range condition, the controller 120 may change the preset target operating temperature to a lower level in consideration of a preset temperature reduction range. In this case, the controller 120 may change the target operating temperature to a lower level so that the preset target operating temperature is reduced by the preset temperature reduction range, as shown in Equation 5 below.

$${x}^{′} = x - t \qquad [ Equation 5 ]$$

Here, x refers to the preset target operating temperature, t refers to the preset temperature reduction range, and x′ may refer to the target operating temperature changed to a lower level.

Meanwhile, in case that the determined change rate satisfies the preset range condition, the controller 120 may change the target operating temperature to a higher or lower level. In one example of the disclosure, it is assumed that the target operating temperature is changed to a lower level in consideration of control efficiency.

However, if the determined change rate does not satisfy the preset range condition, the controller 120 may determine the sign of the change rate and change the preset target operating temperature accordingly. Specifically, referring to FIG. 3, a case in which the sign of the change rate is positive refers to a section (e.g., a second section) where the amount of hydrogen crossover is less than the maximum operating temperature. In this case, the controller 120 may control the preset target operating temperature to a lower level considering a first preset coefficient of variation and change rate. In this case, the first coefficient of variation refers to a value set through a preliminary experiment, and may refer to a value set to correspond to the previously determined dew point. For example, the controller 120 may change the target operating temperature to a lower level by a value obtained by multiplying the first coefficient of variation and the reciprocal of the change rate from the preset target operating temperature as shown in Equation 6 below.

$${x}^{′} = x - γ \frac{\partial x}{\partial y} \qquad [ Equation 6 ]$$

Here, x refers to the preset target operating temperature, γ refers to the first preset coefficient of variation,

$$\frac{\partial x}{\partial y}$$

refers to the reciprocal of the change rate, and x′ may refer to the target operating temperature changed to a lower level.

However, this is an example, and a method for changing the target operating temperature to a lower level is not necessarily limited thereto. For example, it is apparent that the controller 120 may change the target operating temperature to a lower level through a formula optimized to suit the actual operating conditions of the fuel cell stack 110.

If the sign of the change rate is negative, the controller 120 may determine at least one of the outside temperature and the magnitude of the change rate. Further, if the determined outdoor temperature is greater than or equal to a preset reference temperature or the magnitude of the determined change rate is greater than or equal to a preset reference value (e.g., corresponding to a third section), the controller 120 may change the preset target operating temperature to a higher value in consideration of the first coefficient of variation and change rate. This process is performed in the same manner as the process of changing the preset target operating temperature to a lower level if the sign of the change rate is positive as described above. However, as the sign of the change rate is negative, the target operating temperature may be changed to a higher level rather than a lower level. For example, the controller 120 may change the target operating temperature to a higher level to increase the preset target operating temperature by a value multiplied by the first coefficient of variation and the reciprocal of the change rate. However, this is an example, and the method for increasing the target operating temperature is not necessarily limited thereto. For example, it is apparent that the controller 120 may change the target operating temperature to a higher level through a formula optimized to suit the actual operating conditions of the fuel cell stack 110.

In addition or alternative, referring to FIG. 4, in case that the sign of the change rate is negative, at least one of the outside temperature and the magnitude of the change rate is determined, and in case that the determined outside air temperature is less than a preset reference temperature or the magnitude of the determined change rate is less than a preset reference value (for example, a fourth section), the controller 120 may change the preset target operating temperature to a lower level in consideration of the second coefficient of variation that is set to have a higher value than the first preset coefficient of variation, and the change rate.

For example, the controller 120 may change the target operating temperature to a lower level by a value obtained by multiplying the second coefficient of variation and the reciprocal of the change rate from the preset target operating temperature as shown in Equation 7 below.

$${x}^{′} = x + {γ}^{′} \frac{\partial x}{\partial y} \qquad [ Equation 7 ]$$

Here, x is the preset target operating temperature, γ′ is the second coefficient of variation set to have a higher value than the first coefficient of variation,

$$\frac{\partial x}{\partial y}$$

is the reciprocal of the change rate, and x′ may refer to the target operating temperature changed to a lower level.

In this case, the controller 120 may apply the second coefficient of variation that is higher than the first coefficient of variation applied to a case where the sign of the change rate is positive, thereby allowing the downward fluctuation range of the target operating temperature to increase compared to the case where the sign of the change rate is positive. However, this is an example, and the method for changing the target operating temperature to a lower level is not necessarily limited thereto. For example, it is apparent that the controller 120 may change the target operating temperature to a lower level through a formula optimized to suit the actual operating conditions of the fuel cell stack 110.

Meanwhile, the target operating temperature changes within a certain range even if the specifications of the fuel cell stack 110 change, but the change rate of the amount of hydrogen crossover according to the operating temperature may vary according to the specifications of the fuel cell stack 110. Accordingly, if the target operating temperature is changed based only on the change rate as in the example of the disclosure, the changed target operating temperature may be a temperature different from an actual temperature. In order to prevent such problems and set the target operating temperature to be changed close to an actual temperature, in one example of the disclosure, variation coefficients such as the first and second variation coefficients described above may be reflected.

Referring again to FIG. 1, the controller 120 may control the operating temperature of the fuel cell stack 110 based on the changed target operating temperature. For example, if the preset target operating temperature is changed to a higher level, the controller 120 may control the operating temperature of the fuel cell stack 110 using a temperature-raising device (e.g., heat exchangers, electric heaters, catalytic burners, resistance heaters, or hot water circulation systems, etc.) connected to the fuel cell stack 110. The temperature-raising device connected to the fuel cell stack 110 may refer to a COD heater or heat pump device, but this is an example and it is apparent that the device is not necessarily limited thereto.

On the other hand, if the preset target operating temperature is changed to a lower level, the controller 120 may control the operating temperature of the fuel cell stack 110 using a heat radiation device (e.g., cooling fans, radiators, heat sinks, liquid cooling systems, thermoelectric coolers, chilled water systems, cooling jackets, and air conditioning units, etc.) connected to the fuel cell stack 110. The heat radiation device connected to the fuel cell stack 110 may refer to a radiator, but this is an example and it is apparent that the device is not necessarily limited thereto.

Thereafter, the controller 120 may determine whether the fuel cell stack 110 reaches the target operating temperature by controlling the operating temperature of the fuel cell stack 110. In this case, the controller 120 may determine the operating temperature by controlling the operating temperature of the fuel cell stack 110 and determine whether the determined operating temperature reaches the target operating temperature. However, this is an example and it is apparent that this is not necessarily limited thereto. For example, the controller 120 may determine whether the determined operating temperature reaches the target operating temperature in consideration of a preset error range.

If the fuel cell stack 110 reaches the target operating temperature, the controller 120 may determine an idle state maintenance time according to the fuel cell stack 110 entering the idle state. In case that the fuel cell stack 110 continues to be in an idle state, the target operating temperature of the fuel cell stack 110 may continue to change, and as a result, the target operating temperature of the fuel cell stack 110 may be excessively increased or excessively increased.

In order to prevent such problems from occurring, the controller 120 according to an example of the disclosure compares the idle state maintenance time with a preset reference time, and if the idle state maintenance time exceeds the preset reference time, the controller 120 may set the control limit range of the operating temperature for the fuel cell stack 110. By setting the control limit range of the operating temperature, even if the idle state of the fuel cell stack 110 is maintained, the operating temperature of the fuel cell stack 110 may change according to a change in the target operating temperature within the control limit range, and excessive temperature changes in the fuel cell stack 110 may be prevented.

Meanwhile, in case that the idle state of the fuel cell stack 110 is released, the controller 120 may normalize the target operating temperature so that the target operating temperature changed during the idle state is changed to a preset target operating temperature.

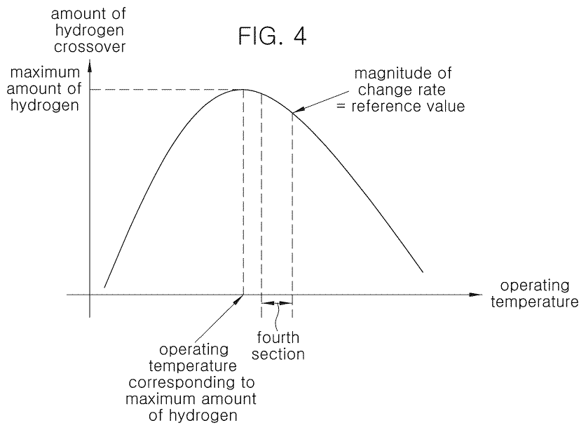

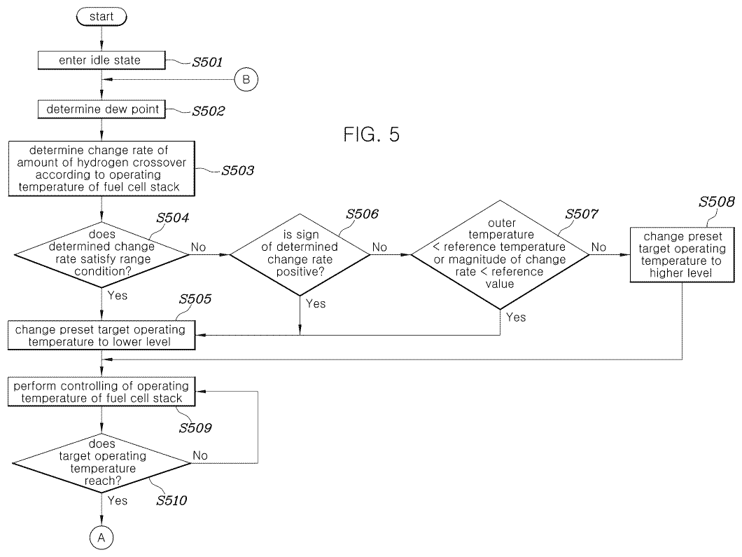

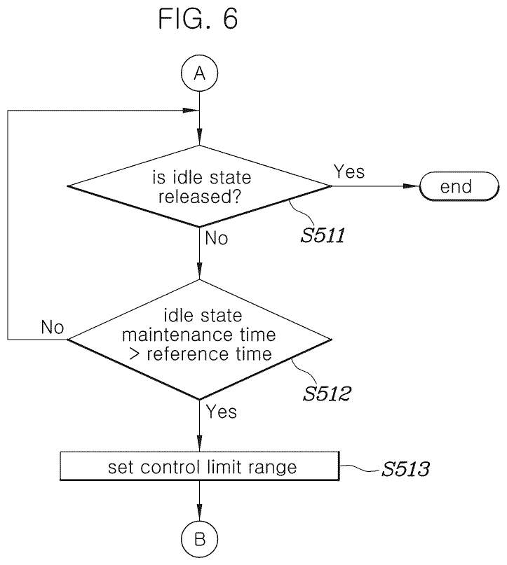

Hereinafter, a method for controlling a fuel cell system according to an example of the disclosure will be described with reference to FIG. 5 and FIG. 6 based on the configuration of the fuel cell system described above with reference to FIGS. 1 to 4.

Hereinafter, detailed descriptions of each step to be described in FIG. 5 and FIG. 6 have been described in detail through FIG. 1 and FIG. 2 and will therefore be omitted for convenience of explanation.

FIG. 5 and FIG. 6 show examples of a method for controlling a fuel cell system according to an example of the disclosure.

Referring to FIG. 5 and FIG. 6, in case that the fuel cell stack 110 enters an idle state (S501), the controller 120 may determine the dew point of the gas flowing in the fuel cell stack 110 (S502). In addition or alternative, the controller 120 may determine the change rate of the amount of hydrogen crossover according to the operating temperature of the fuel cell stack 110 in consideration of the determined dew point (S503).

The controller 120 may determine whether the determined change rate satisfies a preset range condition (S504), and in case that the change rate satisfies the preset range condition (Yes in S504), the controller 120 may change the preset target operating temperature to a lower level in consideration of a preset temperature reduction range (S505).

If the change rate does not satisfy the preset range condition (No in S504), the controller 120 may determine the sign of the determined change rate (S506), and if the determined sign of the change rate is positive (Yes in S506), the controller 120 may change the preset target operating temperature to a lower level in consideration of the first preset coefficient of variation and the determined change rate (S505).

In addition or alternative, in case that the sign of determined change rate is negative (No in S506), the controller 120 may determine at least one of the outside temperature and the magnitude of the change rate and compare the outside air temperature with a preset reference temperature or the magnitude of the change rate with a preset reference value (S507). In case that the outside temperature is less than the preset reference temperature or the magnitude of the change rate is less than the preset reference value (Yes in S507), the controller 120 may change the preset target operating temperature to a lower level in consideration of the second coefficient of variation that is set to have a higher value than the first coefficient of variation, and the determined change rate (S505).

However, in case that the outside temperature is higher than the preset reference temperature or the magnitude of the change rate is higher than the preset reference value (No in S507), the controller 120 may change the preset target operating temperature to a higher level in consideration of the first coefficient of variation and the determined change rate (S508).

Thereafter, the controller 120 may control the operating temperature of the fuel cell stack 110 based on the changed target operating temperature (S509). By controlling the operating temperature of the fuel cell stack 110, the controller 120 may determine whether the fuel cell stack 110 reaches the target operating temperature (S510), and may control the operating temperature of the fuel cell stack 110 until the fuel cell stack 110 reaches the target operating temperature.

In case that the fuel cell stack 110 reaches the target operating temperature (Yes in S510), the controller 120 may determine whether the fuel cell stack 110 has been released from the idle state (S511). In case that the fuel cell stack 110 is released from the idle state (Yes in S511), the controller 120 may terminate control, and in case that the fuel cell stack 110 is not released from the idle state (No in S511), the controller 120 may determine the idle state maintenance time according to the entry of the fuel cell stack 110 into the idle state.

Then, the controller 120 compares the idle state maintenance time with a preset reference time (S512), and in case that the idle state maintenance time exceeds the preset reference time (Yes in S512), the controller 120 may set the control limit rage of the operating temperature for the fuel cell stack 110 (S513). If the control limit range is set, the controller 120 may repeatedly perform S502 and subsequent operations until the fuel cell stack 110 is released from the idle state.

The disclosure is proposed to achieve this object, and is to provide a fuel cell system which may reduce the occurrence of hydrogen crossover in a fuel cell stack by changing a target operating temperature based on the operating temperature of the fuel cell stack and the dew point of gas flowing in the fuel cell stack, and a method for controlling the same.

The technical objects to be achieved by the disclosure are not limited to the technical objects mentioned above, and other technical objects not mentioned may be clearly understood by those skilled in the art from the following descriptions.

In order to achieve the above object, a fuel cell system according to the present disclosure may comprise a fuel cell stack; and a controller configured to determine a dew point of gas flowing in the fuel cell stack, determine a change rate of an amount of hydrogen crossover according to an operating temperature of the fuel cell stack in consideration of the determined dew point, and control the operating temperature of the fuel cell stack while changing a preset target operating temperature based on the determined change rate.

For example, the controller may determine the dew point if the fuel cell stack enters an idle state.

For example, the controller may determine at least one of an outlet temperature of coolant discharged from the fuel cell stack and a relative humidity at a cathode outlet of the fuel cell stack, and determine the dew point based on the at least determined value.

For example, the controller may determine a change rate of an amount of hydrogen crossover according to the operating temperature of the fuel cell stack in consideration of the dew point determined based on a pre-stored derivation equation to derive the amount of hydrogen crossover according to the operating temperature of the fuel cell stack and the dew point of the gas flowing in the fuel cell stack.

For example, if the determined change rate satisfies a preset range condition, the controller may change the target operating temperature to a lower level in consideration of a preset temperature reduction range, and control the operating temperature of the fuel cell stack based on the target operating temperature changed to the lower level.

For example, if the determined change rate does not satisfy a preset range condition, the controller determines a sign of the change rate and, in case that the determined sign of the change rate is positive, the controller may change the target operating temperature to a lower level in consideration of a first preset coefficient of variation and the change rate, and control the operating temperature of the fuel cell stack based on the target operating temperature changed to the lower level.

For example, in case that the determined change rate does not satisfy a preset range condition and a sign of the change rate is negative, the controller may determine at least one of an outside temperature and a magnitude of the change rate, if the outside temperature is less than a preset reference temperature or the magnitude of the change rate is less than a preset reference value, the controller may change the target operating temperature to a lower level in consideration of a second coefficient of variation set to have a higher value than the first coefficient of variation and the change rate.

For example, in case that the determined change rate does not satisfy a preset range condition and a sign of the change rate is negative, if the outside temperature is greater than or equal to a preset reference temperature, or the magnitude of the change rate is greater than or equal to a preset reference value, the controller may change the target operating temperature to a high level in consideration of the first coefficient of variation and the change rate, and control the operating temperature of the fuel cell stack based on the target operating temperature changed to the higher level.

For example, if the target operating temperature changes to a higher level, the controller may control the operating temperature of the fuel cell stack using a temperature-raising device connected to the fuel cell stack, and if the target operating temperature changes to a lower level, the controller may control the operating temperature of the fuel cell stack using a heat radiation device connected to the fuel cell stack.

For example, if the fuel cell stack reaches the target operating temperature by controlling the operating temperature of the fuel cell stack, the controller may determine an idle state maintenance time according to the fuel cell stack entering an idle state, and if the determined idle state maintenance time exceeds a preset reference time, the controller may set a control limit range of the operating temperature for the fuel cell stack.

Further, in order to achieve the above object, a method for controlling a fuel cell system according to the present disclosure may comprise determining a dew point of gas flowing in a fuel cell stack; determining a change rate of an amount of hydrogen crossover according to an operating temperature of the fuel cell stack in consideration of the determined dew point; and controlling the operating temperature of the fuel cell stack while changing a preset target operating temperature based on the determined change rate.

For example, the determining the dew point may comprise determining the dew point if the fuel cell stack enters an idle state.

For example, the determining the change rate may comprise determining a change rate of an amount of hydrogen crossover according to the operating temperature of the fuel cell stack in consideration of the dew point determined based on a pre-stored derivation equation to derive the amount of hydrogen crossover according to the operating temperature of the fuel cell stack and the dew point of the gas flowing in the fuel cell stack.

For example, the controlling may comprise changing the target operating temperature to a lower level in consideration of a preset temperature reduction range if the determined change rate satisfies a preset range condition; and controlling the operating temperature of the fuel cell stack based on the target operating temperature changed to the lower level.

For example, the controlling may comprise determining a sign of the change rate if the determined change rate does not satisfy a preset range condition, and changing the target operating temperature to a lower level in consideration of a first preset coefficient of variation and the change rate in case that the determined sign of the change rate is positive; and controlling the operating temperature of the fuel cell stack based on the target operating temperature changed to the lower level.

For example, the changing to the lower level may comprise determining at least one of an outer temperature and a magnitude of the change rate in case that the determined change rate does not satisfy a preset range condition and a sign of the change rate is negative; and changing the target operating temperature to a lower level in consideration of a second coefficient of variation set to have a higher value than the first coefficient of variation and the change rate if the outside temperature is less that a preset reference temperature, or the magnitude of the change rate is less than a preset reference value.

For example, the controlling may comprise changing the target operating temperature to a high level in consideration of the first coefficient of variation and the change rate, in case that the determined change rate does not satisfy a preset range condition and a sign of the change rate is negative, if the outside temperature is greater than or equal to a preset reference temperature, or the magnitude of the change rate is greater than or equal to a preset reference value; and controlling the operating temperature of the fuel cell stack based on the target operating temperature changed to the higher level.

For example, the method may further comprise, after the controlling determining an idle state maintenance time according to the fuel cell stack entering an idle state if the fuel cell stack reaches the target operating temperature; and setting a control limit range of the operating temperature for the fuel cell stack if the determined idle state maintenance time exceeds a preset reference time.

According to the above, the fuel cell system and method for controlling the same of the disclosure may change the target operating temperature based on the operating temperature and dew point of the fuel cell stack, thereby dynamically controlling the target operating temperature with respect to the humidity of the fuel cell stack that changes depending on the state of the fuel cell stack.

In addition or alternative, by controlling the operating temperature of the fuel cell stack based on the dynamically changed target operating temperature, it is possible to effectively prevent hydrogen from crossing over from the cathode side to the anode side in the fuel cell stack even in various states of the fuel cell stack.

The effects that may be obtained from the disclosure are not limited to the effects mentioned above, and other effects not mentioned will be clearly understood by those skilled in the art from the description below.

According to the above, the fuel cell system and method for controlling the same of the disclosure may change the target operating temperature based on the operating temperature and dew point of the fuel cell stack, thereby dynamically controlling the target operating temperature with respect to the humidity of the fuel cell stack that changes depending on the state of the fuel cell stack.

In addition or alternative, by controlling the operating temperature of the fuel cell stack based on the dynamically changed target operating temperature, it is possible to effectively prevent hydrogen from crossing over from the cathode side to the anode side in the fuel cell stack even in various states of the fuel cell stack.

Although the disclosure has been shown and described in relation to specific examples, those having ordinary skill in the art should appreciate that various improvements and modifications are possible, without departing from the scope and spirit of the disclosure as disclosed in the appended claims.

Furthermore, the term related to a control device such as “controller”, “control apparatus”, “control unit”, “control device”, “control module”, or “server”, etc. refers to a hardware device including a memory and a processor configured to execute one or more steps interpreted as an algorithm structure. The memory stores algorithm steps, and the processor executes the algorithm steps to perform one or more processes of a method in accordance with various examples of the present disclosure. The control device according to examples of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively or additionally, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various examples of the present disclosure.

The aforementioned disclosure may also be implemented as computer readable codes on a computer readable recording medium. The computer readable recording medium is any data storage device that may store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various examples of the present disclosure, each operation described above may be performed by a control device, and the control device may be configured by a plurality of control devices, or an integrated single control device.

In various examples of the present disclosure, the memory and the processor may be provided as one chip, or provided as separate chips.

In various examples of the present disclosure, the scope of the present disclosure includes software or machine-executable commands (e.g., an operating system, an application, firmware, a program, etc.) for enabling operations according to the methods of various examples to be executed on an apparatus or a computer, a non-transitory computer-readable medium including such software or commands stored thereon and executable on the apparatus or the computer.

In various examples of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the examples with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In examples of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the example of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific examples of the present disclosure have been presented for examples and description. They are not intended to be exhaustive or to limit the present disclosure to the precise forms disclosed, and obviously many modifications and variations are possible in light of the above teachings. The examples were chosen and described in order to explain certain principles of the disclosure and their practical application, to enable others skilled in the art to make and utilize various examples of the present disclosure, as well as various alternatives and modifications thereof. It is intended that the scope of the present disclosure be defined by the Claims appended hereto and their equivalents.

What is claimed is:

1. A fuel cell system comprising:
a fuel cell stack; and
a controller configured to:
determine a dew point of gas flowing in the fuel cell stack,
determine, based on the determined dew point and an operating temperature of the fuel cell stack, a change rate of an amount of hydrogen crossover, and
control, based on a target operating temperature, the operating temperature of the fuel cell stack, wherein the target operating temperature is changed based on the determined change rate.

2. The fuel cell system of claim 1, wherein the controller is configured to determine, based on the fuel cell stack entering an idle state, the dew point.

3. The fuel cell system of claim 1, wherein the controller is configured to:
determine at least one of an outlet temperature value of coolant discharged from the fuel cell stack or a relative humidity value at a cathode outlet of the fuel cell stack, and
determine, based on the at least one of the determined outlet temperature value or the relative humidity value, the dew point.

4. The fuel cell system of claim 1, wherein the controller is configured to determine, based on a pre-stored derivation equation, the change rate of the amount of hydrogen crossover, wherein the pre-stored derivation equation derives, based on the operating temperature and the determined dew point, the amount of hydrogen crossover.

5. The fuel cell system of claim 1, wherein the controller is configured to:
change, based on a temperature reduction range and the determined change rate satisfying a range condition, the target operating temperature to a lower level, and
control, based on the target operating temperature changed to the lower level, the operating temperature of the fuel cell stack.

6. The fuel cell system of claim 1, wherein the controller is configured to:
determine, based on the determined change rate not satisfying a range condition, a sign of the change rate,
change, based on the determined sign of the change rate being positive and a first coefficient of variation, the target operating temperature to a lower level, and
control, based on the target operating temperature changed to the lower level, the operating temperature of the fuel cell stack.

7. The fuel cell system of claim 6, wherein the controller is configured to:
determine, based on the determined change rate not satisfying the range condition and the determined sign of the change rate being negative, at least one of an outside temperature or a magnitude of the change rate, and
based on:
the outside temperature being less than a reference temperature or the magnitude of the change rate being less than a reference magnitude, and
a second coefficient of variation which is set to have a higher value than the first coefficient of variation,
change the target operating temperature to a lower level.

8. The fuel cell system of claim 6, wherein the controller is configured to:
based on:
the determined change rate not satisfying the range condition,
the determined sign of the change rate being negative,
the outside temperature being greater than or equal to a reference temperature or a magnitude of the change rate being greater than or equal to a reference magnitude, and
the first coefficient of variation,
change the target operating temperature to a high level; and
control, based on the target operating temperature changed to the higher level, the operating temperature of the fuel cell stack.

9. The fuel cell stack of claim 1, wherein the controller is configured to:
control, based on the target operating temperature changed to a higher level and using a temperature-raising device connected to the fuel cell stack, the operating temperature of the fuel cell stack; and
control, based on the target operating temperature changed to a lower level and using a heat radiation device connected to the fuel cell stack, the operating temperature of the fuel cell stack.

10. The fuel cell stack of claim 1, wherein the controller is configured to:
determine, based on the fuel cell stack reaching the target operating temperature and the fuel cell stack entering an idle state, an idle state maintenance time; and
set, based on the determined idle state maintenance time exceeding a reference time, a control limit range of the operating temperature for the fuel cell stack.

11. A method for controlling a fuel cell system, the method comprising
determining a dew point of gas flowing in a fuel cell stack of the fuel cell system;
determining, based on the determined dew point and an operating temperature of the fuel cell stack, a change rate of an amount of hydrogen crossover; and
controlling, based on a target operating temperature, the operating temperature of the fuel cell stack, wherein the target operating temperature is changed based on the determined change rate.

12. The method of claim 11, wherein the determining the dew point comprises determining, based on the fuel cell stack entering an idle state, the dew point.

13. The method of claim 11, wherein the determining the change rate comprises determining, based on a pre-stored derivation equation, the change rate of the amount of hydrogen crossover, wherein the pre-stored derivation equation derives, based on the operating temperature and the determined dew point, the amount of hydrogen crossover.

14. The method of claim 11, wherein the controlling comprises:
changing, based on a temperature reduction range and the determined change rate satisfying a range condition, the target operating temperature to a lower level; and
controlling, based on the target operating temperature changed to the lower level, the operating temperature of the fuel cell stack.

15. The method of claim 11, wherein the controlling comprises:
determining, based on the determined change rate not satisfying a range condition, a sign of the change rate;
changing, based on the determined sign of the change rate, the target operating temperature to a lower level; and
controlling, based on the target operating temperature changed to the lower level, the operating temperature of the fuel cell stack.

16. The method of claim 15, wherein the changing the target operating temperature to the lower level comprises:
changing, based on the determined sign of the change rate being positive and a first coefficient of variation, the target operating temperature to the lower level; or
determining, based on the determined sign of the change rate being negative, at least one of an outside temperature or a magnitude of the change rate, and based on the outside temperature being less than a reference temperature or the magnitude of the change rate being less than a reference magnitude and a second coefficient of variation which is set to have a higher value than the first coefficient of variation, changing the target operating temperature to the lower level.

17. The method of claim 15, wherein the controlling comprises:
changing the target operating temperature to a high level, wherein the changing the target operating temperature to the high level is based on:
the determined change rate not satisfying the range condition,
the determined sign of the change rate being negative,
an outside temperature being greater than or equal to a reference temperature or a magnitude of the change rate being greater than or equal to a reference magnitude, and
a first coefficient of variation; and
controlling, based on the target operating temperature changed to the higher level, the operating temperature of the fuel cell stack.

18. The method of claim 11, further comprising, after the controlling:
determining, based on the fuel cell stack reaching the target operating temperature and the fuel cell stack entering an idle state, an idle state maintenance time; and
setting, based on the determined idle state maintenance time exceeding a reference time, a control limit range of the operating temperature for the fuel cell stack.

19. The method of claim 11, wherein the determining the dew point comprises:
determining at least one of an outlet temperature value of coolant discharged from the fuel cell stack or a relative humidity value at a cathode outlet of the fuel cell stack; and
determining, based on the at least one of the determined outlet temperature value or the relative humidity value, the dew point.

20. The method of claim 11, wherein the controlling comprises:
controlling, based on the target operating temperature changed to a higher level and using a temperature-raising device connected to the fuel cell stack, the operating temperature of the fuel cell stack; or
controlling, based on the target operating temperature changed to a lower level and using a heat radiation device connected to the fuel cell stack, the operating temperature of the fuel cell stack.
